(19) United States
(12) Patent Application Publication
(10) Pub. No.: US 2025/0265178 A1
(43) Pub. Date: Aug. 21, 2025

(54) System Validation Using Machine-Learning Language Model-Based Integration Tests for Software Applications

(71) Applicant: Maplebear Inc., San Francisco, CA (US)

(72) Inventors: Jacob Jensen, Metuchen, NJ (US); Guanghua Shu, Sunnyvale, CA (US)

(21) Appl. No.: 19/057,848

(22) Filed: Feb. 19, 2025

Related U.S. Application Data
(60) Provisional application No. 63/555,828, filed on Feb. 20, 2024.

(51) Int. Cl. G06F 11/3668; G06F 8/35; G06F 11/3698

(52) U.S. Cl. CPC G06F 11/3688; G06F 8/35; G06F 11/3698

(57) ABSTRACT

An online system performs inference requests in conjunction with the model serving system to perform AI (text-based LLM or multi-modal transformer)-generated integration test variants. Instead of rigid code-specified integration tests, the LLM creates integration test variants that follow a specification. Given one or more files from the codebase of an application and a specification for integration testing, the LLM compiles an integration test including a series of actions (e.g., API calls) as runnable code and assertions about the state of the application after the actions are executed.

### CROSS-REFERENCE TO RELATED APPLICATIONS

This application claims the benefit of U.S. Provisional Application No. 63/555,828, filed on Feb. 20, 2024, which is incorporated herein by reference in its entirety.

### BACKGROUND

Changes to software application design or architecture can break the application on a regular basis. Therefore, integration tests may be important for monitoring the status of applications and addressing errors that occur depending on complex states of the application. However, there are many challenges to developing integration tests. Functions may have many arguments or parameters and input schema can be complex. Many instances or variables are populated through a complex system without full insight into the system. Another difficulty is that writing logic for integration tests can be challenging. In addition, changes to the architecture of the application often require rewrites of the integration tests to reflect the updated changes.

### SUMMARY

In accordance with one or more aspects of the disclosure, the online system obtains, from a client device, a specification for integration testing an application, the specification describing a codebase for the application, and actions and assertions for integration testing. The online system generates a prompt for input to a machine-learning language model, the prompt specifying at least the codebase and a request to generate code for running an integration test matching the actions and assertions. The online system receives, from a model serving system, a response generated by executing the machine-learning model on the prompt, the response including at least code including a sequence of actions and one or more assertions for the sequence of actions. The online system executes the code to perform the sequence of actions for the application. The online system identifies whether a state of the application matches the one or more assertions. Responsive to an identification that an error occurred and the state of the application does not match the assertions, the online system addresses a part of the codebase to resolve the error.

### BRIEF DESCRIPTION OF THE DRAWINGS

FIG. 1A illustrates an example system environment for an online concierge system, in accordance with one or more embodiments.

FIG. 1B illustrates an example system environment for an online concierge system, in accordance with one or more embodiments.

FIG. 2 illustrates an example system architecture for an online concierge system, in accordance with one or more embodiments.

FIG. 3A illustrates a general pattern of generating compiled integration tests by an artificial intelligence (AI) model, in accordance with one or more aspects described herein.

FIG. 3B illustrates an example of generating compiled integration tests by an AI model, in accordance with one or more aspects described herein.

FIG. 4 is a flowchart for a method of integration testing using a machine-learned language model, in accordance with some embodiments.

### DETAILED DESCRIPTION

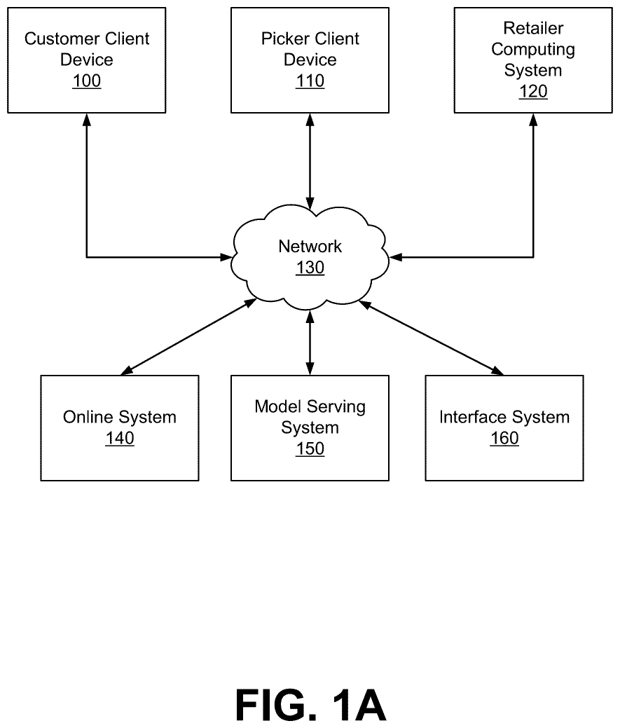

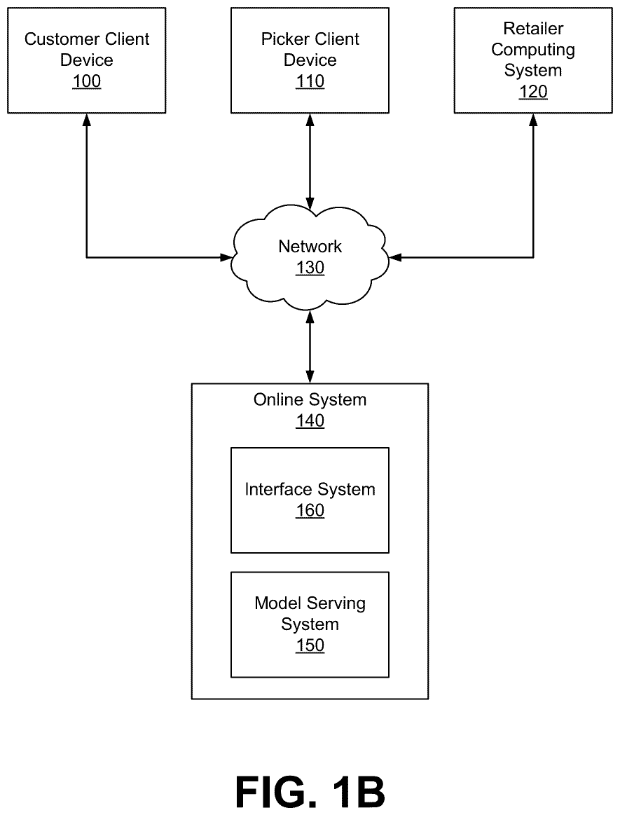

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker client device as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

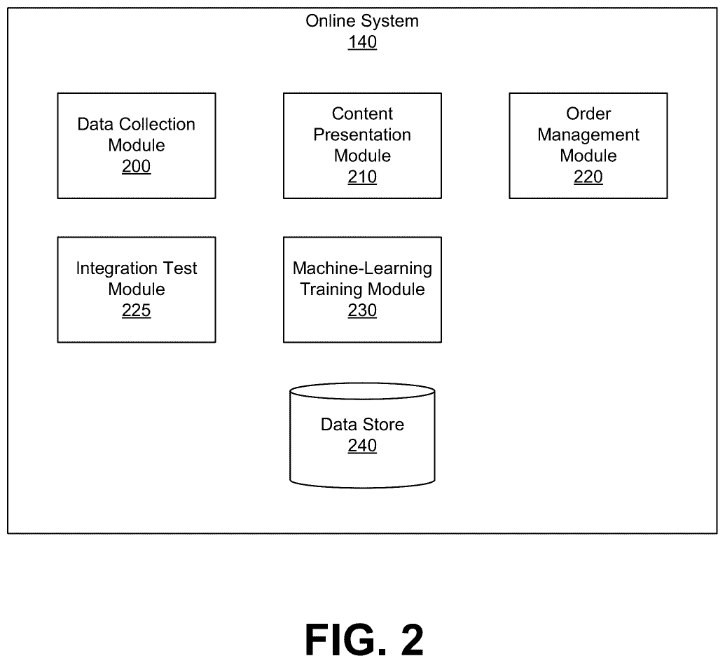

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform inference tasks using machine-learned models. The inference tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbot applications, and the like. In one or more embodiments, the language model is configured as a transformer neural network architecture. Specifically, the transformer model is coupled to receive sequential data tokenized into a sequence of input tokens and generates a sequence of output tokens depending on the inference task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM may be trained by the online system 140 or entities/systems different from the online system 140. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the query. The LLM infers the response to the query from the knowledge that the LLM was trained on and/or from the contextual information included in the prompt.

In one or more embodiments, the online system 140 performs one or more inference tasks in conjunction with the model serving system 150 and/or interface system 160 to generate one or more integration tests for software applications. Specifically, an integration test for a software application is an extensive single or multi-action test that may have complex conditions asserted at different parts of the integration test. Therefore, integration tests may provide invalid, unexpected, or random data to an application and the application is monitored for exceptions such as crashes, memory leaks, and the like.

However, there are many challenges to developing integration tests. Functions may have many arguments or parameters, and input schema can be complex. Many instances or variables are populated through a complex system without full insight into the system. Another difficulty is that writing logic for integration tests can be challenging. In addition, changes to the architecture of the application often require rewrites of the integration tests to reflect the updated changes.

Therefore, in one or more embodiments, the online system 140 described herein performs inference requests in conjunction with the model serving system 150 and/or the interface system 160 to perform AI (text-based LLM or multi-modal transformer)-generated integration test variants. Instead of rigid code-specified integration tests, the LLM creates integration test variants that follow a specification. In one or more embodiments, given one or more files from the codebase of an application and an integration test specification, the LLM compiles an integration test including a series of actions (e.g., API calls) as runnable code and assertions about the state of the application after the actions are executed. In one or more embodiments, the integration test module 225 can easily re-generate the integration test variants using the AI model even if the codebase changes for the application.

In one or more embodiments, the inference task for the model serving system 150 can primarily be based on reasoning and summarization of knowledge specific to the online system 140, rather than relying on general knowledge encoded in the weights of the machine-learned model of the model serving system 150. Thus, one type of inference task may be to perform various types of queries on large amounts of data in an external corpus in conjunction with the machine-learned model of the model serving system 150. For example, the inference task may be to perform question-answering, text summarization, text generation, and the like based on information contained in the external corpus.

Thus, in one or more embodiments, the online system 140 is coupled to an interface system 160. The interface system 160 receives an external corpus of data from the online system 140 and builds a structured index over the data using another machine-learned language model or heuristics. The interface system 160 receives one or more task requests from the online system 140 based on the external data. The interface system 160 constructs one or more prompts for input to the model serving system 150. A prompt may include the task request of the user and context obtained from the structured index of the external data. In one or more instances, the context in the prompt includes portions of the structured indices as contextual information for the query. The interface system 160 obtains one or more responses to the query from the model serving system 150 and synthesizes a response. While the online system 140 can generate a prompt using the external data as context, oftentimes, the amount of information in the external data exceeds prompt size limitations configured by the machine-learned language model. The interface system 160 can resolve prompt size limitations by generating a structured index of the data and offers data connectors to external data and provides a flexible connector to the external corpus.

In this manner, the online system 140 identifies messages for which automated actions or responses can be made, and automatically intercepts conversations on behalf of the receiving party. This allows the online system 140 to eliminate human interaction when responding to action-oriented messages, allowing for automated and efficient processing of customer orders.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 are each managed by an entity separate from the entity managing the online system 140. In one or more embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, an integration test module 225, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information and/or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 may collect order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

In one or more embodiments, the data collection module 200 also collects communication data, which is different types of communication between shoppers and users of the online system 140. For example, the data collection module 200 may obtain text-based, audio-call, video-call based communications between different shoppers and users of the online system 140 as orders are submitted and fulfilled. The data collection module 200 may store the communication information by individual user, individual shopper, per geographical region, per subset of users having similar attributes, and the like.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

In one or more embodiments, the content presentation module 210 receives one or more recommendations for presentation to the customer while the customer is engaged with the ordering interface. The list of ordered items of a customer may be referred to as a basket. As described in conjunction with FIGS. 1A and 1B, the recommendations are generated based on the inferred purpose of the basket of the customer and include one or more suggestions to the customer to better fulfill the purpose of the basket.

In one instance, the recommendations are in the form of one or more equivalent baskets that are modifications to an existing basket that serve the same or similar purpose as the original basket. The equivalent basket is adjusted with respect to metrics such as cost, healthiness, whether the basket is sponsored, and the like. For example, an equivalent basket may be a healthier option compared to the existing basket, a less expensive option compared to the existing basket, and the like. The content presentation module 210 may present the equivalent basket to the customer via the ordering interface with an indicator that states how an equivalent basket improves or is different from the existing basket (e.g., more cost-effective, healthier, sponsored by a certain organization). The content presentation module 210 may allow the customer to swap the existing basket with an equivalent basket.

In one instance, when the basket includes a list of edible ingredients, the recommendations are in the form of a list of potential recipes the ingredients can fulfill, and a list of additional ingredients to fulfill each recipe. The content presentation module 210 may present each suggested recipe and the list of additional ingredients for fulfilling the recipe to the customer. The content presentation module 210 may allow the customer to automatically place one or more additional ingredients in the basket of the customer.

The order management module 220 that manages orders for items from customers. The order management module 220 receives orders from a customer client device 100 and offers the orders to pickers for service based on picker data. For example, the order management module 220 offers an order to a picker based on the picker's location and the location of the retailer from which the ordered items are to be collected. The order management module 220 may also offer an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to offer an order to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Thus, when the order management module 220 receives an order, the order management module 220 may delay in offering the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In one or more embodiments, the order management module 220 facilitates communication between the customer client device 100 and the picker client device 110. As noted above, a customer user may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

As described above, the integration test module 225 performs one or more inference tasks with the model serving system 150 and/or interface system 160 to generate one or more integration tests for software applications. Changes to software application design or architecture can break the application on a regular basis. Therefore, integration tests may be important for monitoring the status of applications and addressing errors that occur depending on complex states of the application.

Therefore, in one or more embodiments, the integration test module 225 may perform inference requests in conjunction with the model serving system 150 and/or the interface system 160 to perform AI (text-based LLM or multi-modal transformer)-generated integration test variants.

In one or more embodiments, the integration test module 225 may perform LLM-based fuzzing, such that random sequences of inputs are provided to the functions designed to identify low-level bugs in the code. In one or more embodiments, the AI model may take an integration test specification and compile an integration test and variants of that test in a random but plausible way, such that invalid, unexpected, and/or random data is provided to the application. As the application advances to each state, the integration test module 225 may determine whether there are any errors in the application that are triggered via these tests and address these errors in the codebase. As described in further detail below, the integration test module 225 can compile integration tests via introspection into the application's codebase to generate “fuzzed” variants or in another instance, perform inspection of the application's user interface (UI) operations to determine viable courses of action to generate “UI” variants of the test.

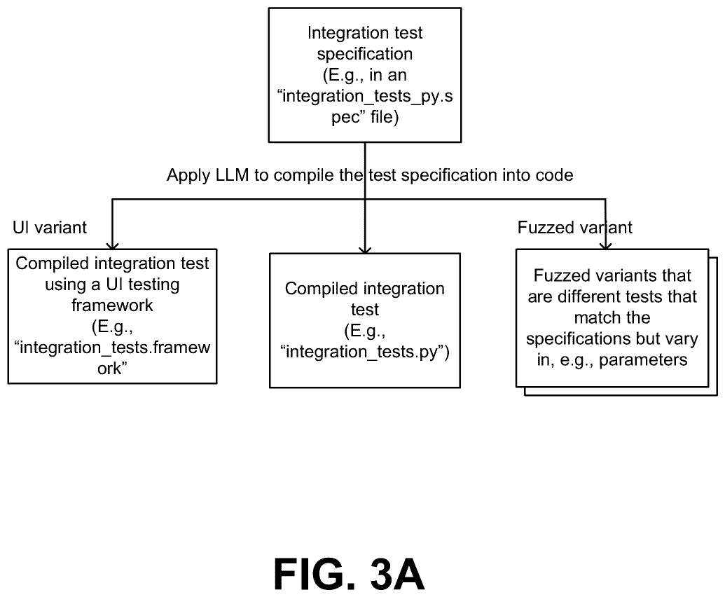

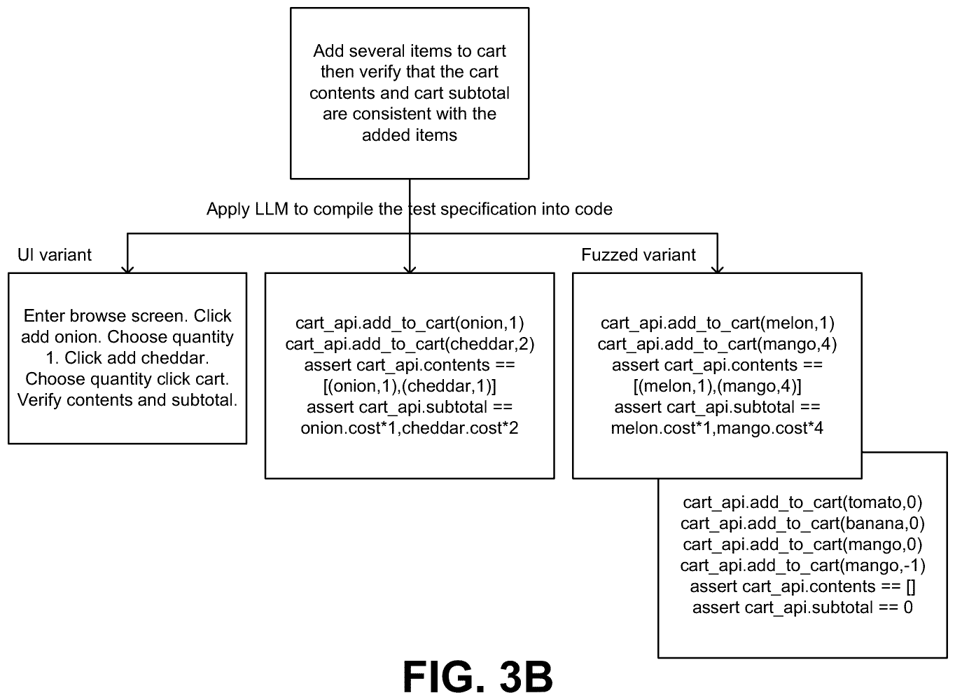

FIG. 3A illustrates a general pattern of generating compiled integration tests by an AI model, in accordance with one or more aspects described herein. FIG. 3B illustrates an example of generating compiled integration tests by an AI model, in accordance with one or more aspects described herein. As illustrated in FIG. 3A, the LLM (or any AI model) may access a codebase and a test specification. In one instance, the specification for an integration test can include a request to perform a random path of actions, and an assertion of the state the test would expect to obtain. For example, as illustrated in FIG. 3B, a specification for an integration test can specify a request to search items, add one or more items to a cart, then verify that the cart contents and the cart subtotal are consistent with the added items per checkout. That is, the assertion is to check whether the subtotal of the cart is the same as the price of the items in the cart. In one instance, the specification is stored in a .spec file.

The LLM may compile the integration test specification into runnable code. Specifically, given at least a portion of the codebase of an application and a prompt including the request, the LLM compiles the code by inferring schema for various functions in the codebase, for example, the types of inputs that can be sent to a function, how to infer a state of an object, types of outputs from the function, and the like. The prompt may additionally include previous examples of integration tests. Based on the inferred schemas, the LLM may compile runnable code for the test specification by identifying the sequence of appropriate functions or API's and their input parameters. The LLM determines whether the assertion in the specification is met from the current state of the application.

Returning to the example illustrated in FIG. 3B, an example compiled integration test is a sequence of API calls “cart_api.add_to_cart(onion, 1), cart_api.add_to_cart(cheddar, 2).” The code “assert cart_api.contents==[(onion, 1), (cheddar, 2)], assert cart_api.subtotal==onion.cost*1+cheddar.cost*2” determines whether the state of the cart after the two API calls does in fact include 1 onion and 2 cheddar cheeses, and whether the subtotal of the cart matches the prices of 1 onion and 2 cheddar cheeses. As described above, based on access to the codebase (cart.py and item.py files), the LLM may infer schemas of various functions or API's in the codebase to compile code for an integration test that matches the specification.

As described above, in one or more embodiments, the integration test module 225 creates one or more fuzzed variants based on the specification that are many instances (e.g., hundreds, thousands) of slightly different integration tests that match the specification but vary in the sequence of actions or specific parameters to the functions or API's. The integration test module 225 may submit a prompt to the LLM that includes a request to generate fuzzed variants based on the specification and the codebase, as well as any examples of previous instances of integration tests. While generating these variants that are random and/or unexpected can be a difficult process to do manually, the AI model can automatically generate these variants given a specification, codebase, and other example tests, saving significant time and resources in the field of integration testing for software applications.

As an example, a first fuzzed variant includes “cart_api.add_to_cart(watermelon, 1), cart_api.add_to_cart(mango, 4)” which specify different types of inputs to the add_to_cart function. The code “assert cart_api.contents==[(watermelon, 1), (mango, 4)], assert cart_api.subtotal==watermelon.cost*1+mango.cost*4” determines whether the state of the cart after the two API calls does in fact include the five items, and whether the subtotal in the cart matches the price of the five items. As another example, a second fuzzed variant includes “cart_api.add_to_cart(tomato, 0), cart_api.add_to_cart(banana, 0), cart_api.add_to_cart(mango, 1), cart_api.add_to_cart(mango, −1)” which specify no instance of tomato was added, no instance of banana was added, an instance of mango was added and then deleted in the cart. The code “assert cart_api.contents==[ ], assert cart_api.subtotal==0” determines whether the state of the cart does in fact include zero items, and whether the subtotal in the cart includes 0 dollars. The integration test module 225 may monitor the assertions, and for any variant that has an incorrect assertion, a developer of the application can address any errors in the codebase.

Moreover, as described above, the codebase is changed or otherwise updated to incorporate new functionalities, new function names, new parameters, and the like. However, because of the system and method described herein, even the same specification can be used to recompile the integration test and variants when the codebase is updated or changed in some manner. In such an instance, the LLM is able to determine the relevant functions (even if their names have been updated) and required input parameters that are relevant to the specification.

In one or more embodiments, as described above, the integration test module 225 prompts a multi-modal LLM or transformer model to formulate the sequence of actions as a sequence of interactions (e.g., click-action, hovering action of the user) on a UI generated by the application. The integration test module 225 may do so in conjunction with a browser emulator and testing framework that emulates user interaction with the UI. The testing framework may include one or more tools or libraries that a user developer can use to automate browser testing in one or more programming languages. For example, the framework allows identification and location of elements within a web page by matching a pattern against the structure and attributes of the HTML of the webpage. The multi-modal LLM can analyze screen shots of the UI to determine valid sequences of actions. The state of interest is the screen shot of the application UI. The assertion would determine whether the correct UI page is rendered after the sequence of actions with the correct state information, instead of some error (e.g., unexpected application closing).

As described above, in one or more embodiments, the integration test module 225 may create one or more UI variants for integration tests based on the specification using a UI testing framework, such as Selenium. The integration test module 225 may submit a prompt to the LLM that includes a request to generate UI variants based on the specification and the codebase (that may include code for rendering the UI), as well as any examples of previous instances of UI-based integration tests. As illustrated in FIG. 3B, an example UI variant is a sequence of actions “Enter browser screen. Click on add onion. Choose quantity 1. Click on add cheddar button. Choose quantity 2. Click add to cart. Verify contents and subtotal.” where each action can be generated by the cross-modal LLM from a screenshot of the UI (e.g., GPT-V identifies “add item” button for onion item, GPT-V identifies “add to cart” button on the screen) and emulated via an API for the browser emulator. In one or more embodiments, each action may be represented by code in a programming language that uses the tools and libraries of the testing framework to simulate one or more interactions with the web page or web application. At the end of this sequence of actions, the integration test module 225 may confirm whether the subtotal of the cart presented on the UI matches items that have been added (or deleted) to the cart.

In one or more embodiments, the integration test module 225 may deploy an LLM-powered tool that interacts with the graphical user interface (GUI) of a computer system to enable execution of tasks within a visual environment. In one or more embodiments, the LLM-powered tool traverses a local application, or a web application deployed by the online system 140 to simulate one or more quality assurance steps, with the goal of simulating paths that expose potential weaknesses or stringent conditions in the application.

In one or more embodiments, the integration test module 225 may generate inputs or a prompt to the LLM-powered tool that specifies a request to simulate a quality assurance test on a given application and provide stringent testing on the application. The LLM-powered tool may simulate navigation of the website by taking a sequence of actions, in which each action may interact with the application, such as invoking an API call, interaction with a UI of the application presented on the GUI of the computer system, and the like. The integration test module 225 compares the values at one or more target destinations with a desired outcome, and verifies whether the application worked as expected.

For example, the integration test module 225 may provide inputs or prompts requesting simulation of quality assurance to test whether a particular user profile is correctly being presented with vegan options. The LLM-powered tool may take a series of actions (e.g., clicking a series of UI elements to add items) to present a list of recommended items for a user that is associated with a vegan diet. The integration test module 225 may compare the target destination of the list of items with the desired goal of presenting vegan options to the simulated user, and verify whether the application is working as expected.

In one or more embodiments, the integration test module 225 may record the navigated paths taken by the LLM-powered tool, and convert certain paths into integration tests. The integration test module 225 may create a significant large library of tests. The integration test module 225 further creates variants of such integration tests. The integration tests described with respect to FIGS. 3A-3B may be relatively static as it includes a series of predetermined commands. However, by deploying the LLM-powered tool described herein, the integration test module 225 can simulate more natural decision-making paths that users are expected to take by using a visual environment (e.g., GUI) of the computer system and requesting an agent to interact with the visual environment.

The machine learning training module 230 trains machine learning models used by the online system 140. For example, the machine learning module 230 may train the item selection model, the availability model, or any of the machine-learned models deployed by the model serving system 150. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

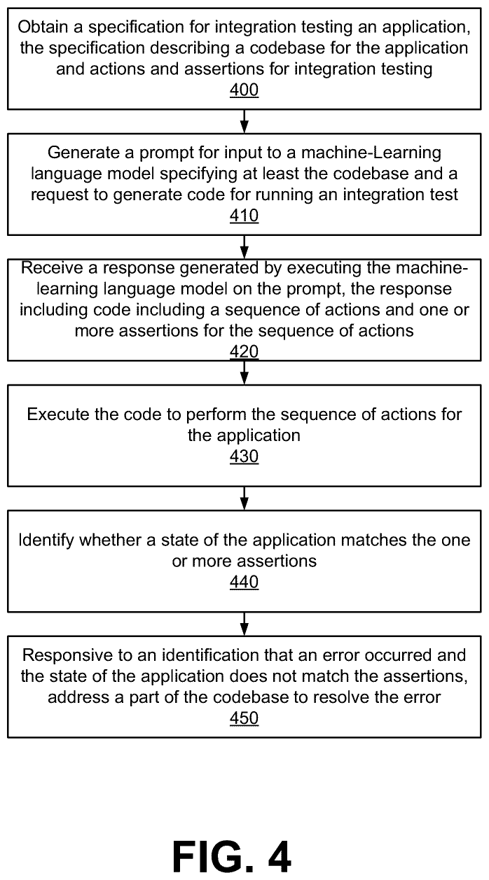

FIG. 4 is a flowchart for a method of integration testing using a machine-learning language model, in accordance with some embodiments. Alternative embodiments may include more, fewer, or different steps from those illustrated in FIG. 4, and the steps may be performed in a different order from that illustrated in FIG. 4. These steps may be performed by an online concierge system (e.g., online system 140). Additionally, each of these steps may be performed automatically by the online concierge system without human intervention.

The online system 140 obtains 400, from a client device, a specification for integration testing an application, the specification describing a codebase for the application, and actions and assertions for integration testing. The online system 140 generates 410 a prompt for input to a machine-learning language model, the prompt specifying at least the codebase and a request to generate code for running an integration test matching the actions and assertions. The online system 140 receives 420, from a model serving system, a response generated by executing the machine-learning model on the prompt, the response including at least code including a sequence of actions and one or more assertions for the sequence of actions. The online system 140 executes 430 the code to perform the sequence of actions for the application and determine whether a state of the application matches the one or more assertions. The online system 140 identifies 440 whether, responsive to an identification that an error occurred and the state of the application does not match the one or more assertions, a part of the codebase may be addressed to resolve the error. For example, an application developer may investigate the cause of the error and update the application codebase to address the errors.

### Additional Considerations

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
obtaining, by an online computing system having at least one processor and memory, and from a client device, a specification for integration testing an application, the specification describing a codebase for the application, and actions and assertions for integration testing;
generating, by the at least one processor, a prompt for input to a machine-learning language model, the prompt specifying at least the codebase and a request to generate code for running an integration test matching the actions and assertions;
receiving, by the at least one processor, a response generated by executing the machine-learning language model on the prompt, the response including at least code including a sequence of actions and one or more assertions for the sequence of actions;
executing, by the at least one processor, the code to perform the sequence of actions for the application;
identifying, by the at least one processor, whether a state of the application matches the one or more assertions; and
responsive to an identification that an error occurred and the state of the application does not match the one or more assertions, modifying, by the at least one processor, a part of the codebase to resolve the error.

2. The method of claim 1, further comprising:
generating, by the at least one processor, a set of fuzzed variants based on the specification for integration testing, wherein a fuzzed variant in the set includes a different sequence of actions or different parameters to function calls or application programming interface (API) calls from the sequence of actions.

3. The method of claim 2, wherein generating the set of fuzzed variants further comprises:
generating, by the at least one processor, a second prompt for input to the machine-learning language model or a second model, the second prompt including at least the specification, the codebase, and a request to generate fuzzed variants based on the specification;
receiving, by the at least one processor, a second response generated by executing the machine-learned language model or the second model on the second prompt; and
parsing, by the at least one processor, the second response to obtain the set of fuzzed variants.

4. The method of claim 1, wherein each action in the sequence of actions is an invocation of one or more application programming interface (API) calls or one or more function calls.

5. The method of claim 1, wherein each action in the sequence of actions is a simulation of a respective interaction with a web element rendered on an interface of the application, and wherein identifying whether the state of the application matches the one or more assertions further comprises:
obtaining, by the at least one processor, at least an image of the interface of the application after executing the code; and
identifying. by the at least one processor, whether a state of the interface rendered in the image displays a desired state.

6. The method of claim 1, wherein the sequence of actions represents adding one or more items to a user's order, and the state of the application is a total cost or a content of the user's order after adding the one or more items to the user's order.

7. The method of claim 1, further comprising:
responsive to verifying that the sequence of actions is a valid integration test, generating, by the at least one processor, a training example including the prompt and the response;
applying, by the at least one processor, parameters of the machine-learning language model to the prompt to generate an estimated output; and
updating, by the at least one processor, the parameters based on a loss function indicating a difference between the estimated output and the response.

8. A non-transitory computer-readable medium storing instructions that, when executed by one or more computer processors, cause the one or more computer processors to perform operations comprising:
obtaining, from a client device, a specification for integration testing an application, the specification describing a codebase for the application, and actions and assertions for integration testing;
generating a prompt for input to a machine-learning language model, the prompt specifying at least the codebase and a request to generate code for running an integration test matching the actions and assertions;
receiving a response generated by executing the machine-learning language model on the prompt, the response including at least code including a sequence of actions and one or more assertions for the sequence of actions;
executing the code to perform the sequence of actions for the application;
identifying whether a state of the application matches the one or more assertions; and
responsive to an identification that an error occurred and the state of the application does not match the one or more assertions, modifying a part of the codebase to resolve the error.

9. The non-transitory computer-readable medium of claim 8, the operations further comprising:
generating a set of fuzzed variants based on the specification for integration testing, wherein a fuzzed variant in the set includes a different sequence of actions or different parameters to function calls or application programming interface (API) calls from the sequence of actions.

10. The non-transitory computer-readable medium of claim 9, wherein the operations for generating the set of fuzzed variants further comprises:
generating a second prompt for input to the machine-learning language model or a second model, the second prompt including at least the specification, the codebase, and a request to generate fuzzed variants based on the specification;
receiving a second response generated by executing the machine-learned language model or the second model on the second prompt; and
parsing the second response to obtain the set of fuzzed variants.

11. The non-transitory computer-readable medium of claim 8, wherein each action in the sequence of actions is an invocation of one or more application programming interface (API) calls or one or more function calls.

12. The non-transitory computer-readable medium of claim 8, wherein each action in the sequence of actions is a simulation of a respective interaction with a web element rendered on an interface of the application, and wherein the operations for identifying whether the state of the application matches the one or more assertions further comprises:
obtaining at least an image of the interface of the application after executing the code; and
identifying whether a state of the interface rendered in the image displays a desired state.

13. The non-transitory computer-readable medium of claim 8, wherein the sequence of actions represents adding one or more items to a user's order, and the state of the application is a total cost or a content of the user's order after adding the one or more items to the user's order.

14. The non-transitory computer-readable medium of claim 8, the operations further comprising:
responsive to verifying that the sequence of actions is a valid integration test, generating a training example including the prompt and the response;
applying parameters of the machine-learning language model to the prompt to generate an estimated output; and
updating the parameters based on a loss function indicating a difference between the estimated output and the response.

15. A computer system, comprising:
one or more processors; and
a non-transitory computer-readable medium storing instructions that, when executed by one or more computer processors, cause the one or more computer processors to perform operations comprising:
obtaining, from a client device, a specification for integration testing an application, the specification describing a codebase for the application, and actions and assertions for integration testing;
generating a prompt for input to a machine-learning language model, the prompt specifying at least the codebase and a request to generate code for running an integration test matching the actions and assertions;
receiving a response generated by executing the machine-learning language model on the prompt, the response including at least code including a sequence of actions and one or more assertions for the sequence of actions;
executing the code to perform the sequence of actions for the application;
identifying whether a state of the application matches the one or more assertions; and
responsive to an identification that an error occurred and the state of the application does not match the one or more assertions, modifying a part of the codebase to resolve the error.

16. The computer system of claim 15, the operations further comprising:
generating a set of fuzzed variants based on the specification for integration testing, wherein a fuzzed variant in the set includes a different sequence of actions or different parameters to function calls or application programming interface (API) calls from the sequence of actions.

17. The computer system of claim 16, wherein the operations for generating the set of fuzzed variants further comprises:
generating a second prompt for input to the machine-learning language model or a second model, the second prompt including at least the specification, the codebase, and a request to generate fuzzed variants based on the specification;
receiving a second response generated by executing the machine-learned language model or the second model on the second prompt; and
parsing the second response to obtain the set of fuzzed variants.

18. The computer system of claim 15, wherein each action in the sequence of actions is an invocation of one or more application programming interface (API) calls or one or more function calls.

19. The computer system of claim 15, wherein each action in the sequence of actions is a simulation of a respective interaction with a web element rendered on an interface of the application, and wherein the operations for identifying whether the state of the application matches the one or more assertions further comprises:
obtaining at least an image of the interface of the application after executing the code; and
identifying whether a state of the interface rendered in the image displays a desired state.

20. The computer system of claim 15, wherein the sequence of actions represents adding one or more items to a user's order, and the state of the application is a total cost or a content of the user's order after adding the one or more items to the user's order.
